(19) United States
(12) Patent Application Publication
(10) Pub. No.: US 2009/0316749 A1
(43) Pub. Date: Dec. 24, 2009

(54) SUBSTRATE TEMPERATURE MEASUREMENT BY INFRARED TRANSMISSION IN AN ETCH PROCESS

(76) Inventor: Matthew Fenton Davis, Felton, CA (US)

Correspondence Address: PATTERSON & SHERIDAN, LLP - - APPM/TX, 3040 POST OAK BOULEVARD, SUITE 1500, HOUSTON, TX, 77056, US

(21) Appl. No.: 12/144,157

(22) Filed: Jun. 23, 2008

(51) Int. Cl. G01J 5/12

(52) U.S. Cl. 374/132; 374/E01.001

(57) ABSTRACT

A method and apparatus for measuring a temperature during a process are provided. In one embodiment, an apparatus for measuring a substrate temperature during an etching process is provided that includes a chamber body, a chamber lid enclosing the chamber body and a substrate support assembly. A plurality of windows formed in a substrate supporting surface of the substrate support assembly. A signal generator is optically coupled through the substrate support assembly to the windows. A sensor is positioned above the substrate support and aligned to receive energy transmitted from the signal generator through at least one of the windows, wherein the sensor is configured to detect a metric indicative of transmittance.

### BACKGROUND

1. Field

Aspects of the present invention generally relate to a method and apparatus for measuring a semiconductor substrate temperature. More specifically, aspects of the present invention relate to a method and apparatus for measuring a semiconductor substrate temperature in an etch process by substrate infrared transmission.

2. Description of the Related Art

Ultra-large-scale integrated (ULSI) circuits may include more than one billion electronic devices (e.g., transistors) that are formed on a semiconductor substrate, such as a silicon (Si) substrate, and cooperate to perform various functions within the device. During processing, a number of thermal processing steps is occasionally performed on the substrate surface. Thermal processing typically requires precise substrate temperature measurement for process control. Inaccurate substrate temperature control may result in poor process results that may adversely influence device performance and/or result in substrate film material damage.

Different types of temperature measurement tools may be used to measure substrate temperature during processing. For example, thermocouples are often used to measure a substrate temperature by physically contacting the substrate at predetermined locations on the substrate surface. However, with larger diameter substrates, the overall temperature variation across substrate surface is difficult to determine due to the large distances between measurement locations. Furthermore, the reliability of the thermal physical contact of the thermocouples to the substrate surface is hard to control and has contamination concerns.

Alternatively, optical pyrometry is sometimes used to measure substrate temperature. Radiation emitted from the substrate surface during processing is measured by an optical pyrometry sensor to determine the substrate temperature. However, the measurement of optical emissions from substrate surface is difficult to separate from background noise, such as intense lighting from heating elements or heat from a plasma source, optical emissions from chamber wall and/or stray light from windows. As the optical emissions from the substrate surface may not be accurately measured and the background noise may further introduce error to temperature measurement, the actual substrate surface temperature is difficult to precisely measure, which may result in erroneous substrate temperature determination and consequently poor processing results.

Therefore, there is a need for an improved method and apparatus for substrate temperature measurement.

### SUMMARY

A method and apparatus for measuring a temperature during a process are provided. In one embodiment, an apparatus for measuring a substrate temperature during an etching process is provided that includes a chamber body, a chamber lid enclosing the chamber body and a substrate support assembly. A plurality of windows formed in a substrate supporting surface of the substrate support assembly. A signal generator is optically coupled through the substrate support assembly to the windows. A sensor is positioned above the substrate support and aligned to receive energy transmitted from the signal generator through at least one of the windows, wherein the sensor is configured to detect a metric indicative of transmittance.

In another embodiment, a method of measuring a substrate temperature during an etching process is provided that includes providing a substrate in a process chamber, performing an etching process on the substrate, detecting a change in transmittance of the substrate while etching, and determining a temperature of the substrate based on the change in transmittance.

In yet another embodiment, a method for measuring temperature during a process performed on a workpiece is provided that includes performing a process on a workpiece which changes the temperature of the workpiece, passing an infrared light through the workpiece while performing the process, detecting a metric of the transmitted infrared light indicative of the transmissivity of the workpiece, and calculating a workpiece temperature based on the detected metric.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIGS. 1A-C depict simplified schematic diagrams of an exemplary processing apparatus suitable for practice the present invention;

FIG. 2 depicts a graph illustrating a silicon substrate transmissivity verses IR light wavelength at different substrate temperatures;

FIG. 3 depicts a graph illustrating silicon substrate transmissivity verses substrate temperature at a certain IR light wavelength;

FIG. 4 depicts a graph illustrating transmitted energy verses time;

FIG. 5A depicts a schematic diagram of an exemplary processing apparatus configured to practice the present invention;

FIGS. 5B-C depict top views of different embodiments of a substrate support assembly disposed in the processing apparatus of FIG. 5A; and

FIG. 6 depicts a schematic diagram, of an exemplary processing system having at least one of the apparatus of FIG. 5A incorporated thereto to practice the present invention.

To facilitate understanding, identical reference numerals have been used, where possible, to designate identical elements that are common to the figures. It is contemplated that elements and features of one embodiment may be beneficially incorporated in other embodiments without further recitation.

It is to be noted, however, that the appended drawings illustrate only exemplary embodiments of this invention and are therefore not to be considered limiting of its scope, for the invention may admit to other equally effective embodiments.

### DETAILED DESCRIPTION

Embodiments of the present invention provide a method and apparatus for measuring a substrate temperature during an etching process. In one embodiment, the substrate temperature may be determined by monitoring changes in the transmittance of energy through a substrate. Exemplary plasma process include etching, deposition, annealing, plasma surface treating and ion implantation, among others.

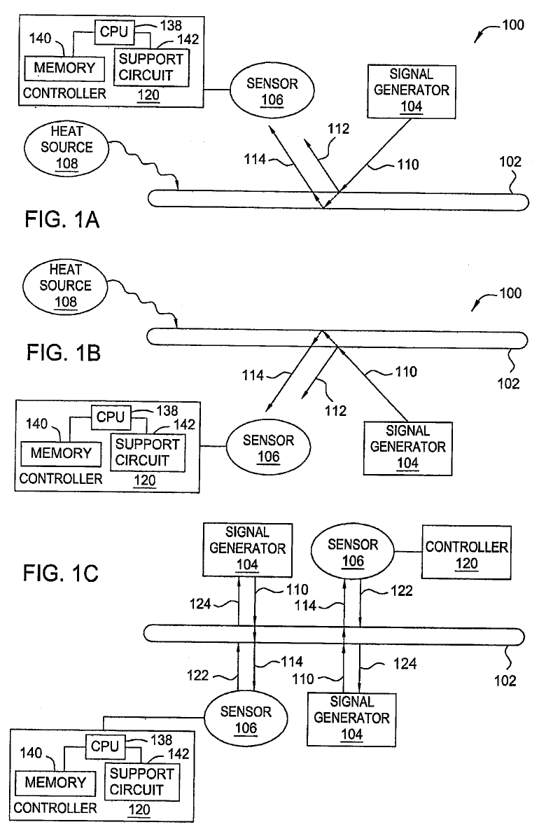

FIGS. 1A-1C depict a simplified schematic diagram of a processing apparatus suitable for practice the present invention. The simplified processing apparatus 100 is operated under vacuum. The apparatus 100 includes a heat source 108 adapted to provide thermal energy to a substrate 102 disposed in the apparatus 100. In one embodiment, the heat source 108 is provided from a plasma generated adjacent to the substrate 102. In another embodiment, the heat source 108 may alternatively be provided by a heated substrate holder, a heated support pedestal, a resistive heater or other heat source suitable for raising the temperature of the substrate.

In the embodiment depicted in FIG. 1A, a signal generator 104 and a sensor 106 are disposed above an upper side of the substrate 102. The signal generator 104 is disposed above the substrate 102 and generates a signal 110 that is transmitted through the substrate 102. The signal generator 104 may be an energy source that provides energy having at least one wavelength that may be transmittance through the substrate 102, and may include lasers and broad band light sources. As the signal 110 hits the substrate 102, a portion 112 of the signal 110 is directly reflected from the upper surface of the substrate. Another portion 114 of the signal 110 is transmitted through, and at least partially absorbed by, the substrate 102. The portion 114 of the signal 110 transmitted through the substrate 102 reflected from a bottom of the substrate 102. A sensor 106 is utilized to receive the signal 114 reflected off the bottom of the substrate 102. A filter (not shown) may be employed to screen the signal 112 reflected to the sensor 106 which has not passed through the substrate 102.

A controller 120 is connected to the sensor 106 to analyze the signal received. The controller 120 generally includes a central processing unit (CPU) 138, a memory 140, and support circuit 142. The CPU 138 may be one of any form of a general purpose computer processor that can be used in an industrial setting. The support circuits 142 are conventionally coupled to the CPU 138 and may comprise cache, clock circuits, input/output subsystems, power supplies, and the like. The software routines when executed by the CPU 138, transform the CPU 138 into a specific purpose computer (controller) 144. The software routines may also be stored and/or executed by a second controller (not shown) that is located remotely from the system 100.

Similar to the configurations of FIG. 1A, FIG. 1B depicts another embodiment wherein the signal generator 104 and the sensor 106 are disposed below a bottom side of the substrate 102.

FIG. 1C depicts yet another embodiment wherein the signal generator 104 and sensor 106 are disposed on the opposite sides of the substrate 102. The signal generator 104 is disposed above the substrate 102 and generates a signal 110. The sensor 106 is disposed at a position opposite to the signal generator 104 to receive a portion 114 of the signal 110 passing through the substrate 102. A secondary reflected signal 122 may be reflected from the sensor 106 and transmitted a portion 124 of the signal 122 through the substrate 102 further back to the upper side of the substrate 102. Accordingly, one or more sets of the signal generator 104 and sensor 106 may be utilized to be disposed in different sides of the substrate 102 to generate and receive signals 114, 124 incurred in any directions during the process.

Different substrate materials may have different transmittance of light at different temperatures and different wavelengths. As the heat source 108 provides thermal energy to the substrate surface, the substrate temperature changes. A portion 114 of the signal 110 is transmitted through the substrate 102 while anther portion is absorbed. The amount of the signal transmitted through the substrate 102 is dependent on the temperature of the substrate 102. Thus, as the substrate 102 is heated, the amount of the signal 114 transmitted through the substrate 102 to the sensor 106. The sensor 106 detects the changes in the signal 114 which are indicative of the temperature of the substrate 102. Based on the change of the detected signal 114 the substrate temperature may be determined accordingly.

In one embodiment, the signal generator 104 may be a light generator having different wavelengths. For example, the signal generator 104 may provide a laser beam having a narrow band of wavelength centered in the range between about 1000 nm and about 1400 nm. In another embodiment, the signal generator 104 may provide a light energy having a wavelength between about 1100 nm and about 1300 nm.

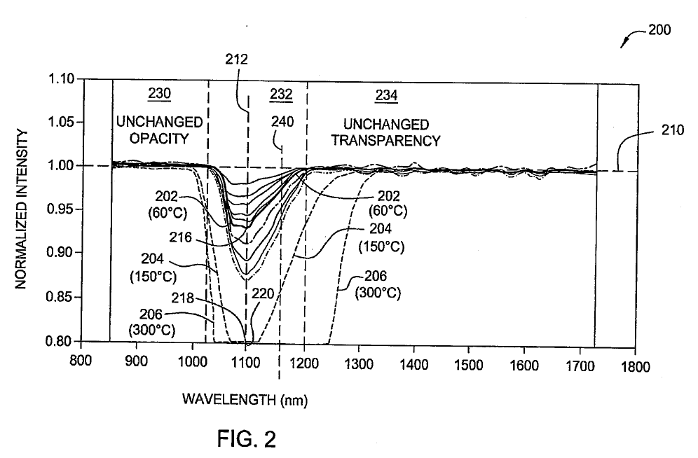

FIG. 2 depicts light spectrum traces of a substrate using silicon as substrate material at different substrate temperatures and at different wavelengths. The spectrum traces 202, 204, 206 depict the transmissivity of silicon semiconductor material as a function of wavelength at different temperatures. In one embodiment, the transmissivity as measured has been normalized to base silicon opacity at a room temperature, e.g., approximately about 25 degrees Celsius, as a base line, as shown by the phantom line 210 pointing to value 1.00. The subsequent measurement of substrate transmissivity is a relative and fractional optical transmission to what is measured relative to the normalized base line as the substrate temperature elevates. It is noted that normalization and fractional and relative substrate optical transmission measurement allows elimination of the substrate insensitivity, such as substrate having different substrate dopants or different materials disposed thereon, thereby standardizing the substrate temperature measurement process.

The traces illustrate that transmissivity may be correlated to substrate temperature at a given wavelength range. For example, at a first wavelength of less than about 1000 nm in a first zone 230, the substrate remains substantially opaque to IR light with regardless substrate temperature change. At a second wavelength of greater than about 1250 nm in a second zone 234, the substrate remains substantially transparent to IR light with regardless substrate temperature change. In contrast, at a wavelength between about 1000 nm and about 1250 nm, as illustrated in a third zone 232, the substrate transmissivity changes rapidly. Thus, for the wavelength range of the third zone 232, as the substrate temperature increases, the slope of each transmissivity trace line 202, 204, 206 changes. Thus, by selection of a wavelength having a slope sufficient to obtain good measurement resolution, the change of the substrate temperature may be determined by detecting a change in intensity. Furthermore, since different wavelengths in the third zone 232 have different substrate temperature behavior, a wavelength may be selected over which a change in transmissivity is rapid for the temperature of interest. To ensure good resolution when determining the temperature of interest, a wavelength needs to be carefully selected for which the substrate has a rapid change in transmissivity over a range of temperatures that includes the temperature of interest. For example, at a light wavelength 212 of about 1100 nm, the substrate temperature increase causes the transmissivity of silicon substrate to change rapidly between a first point 216 on trace line 202 toward a second point 218 to a third point 220. The change in signal intensity value of these points 216, 218, 220 are within range (e.g., greater than 0.2 in signal intensity) within range reliably detectable by a controller, thereby enabling the controller to accurately read the signal intensity value detected and precisely determine the substrate temperature based on the measured signal intensity. In one embodiment, the controller is configured to determine temperature change of the substrate at wavelength about 1100 nm ranges from about 25 degrees Celsius to about 350 degrees Celsius. In contrast, at a light wavelength 240 of about greater than 1200 nm, substrate temperature greater than about 300 degrees Celsius may fall out a detectable range as the change in signal intensity is relatively low as compared to a substrate temperature less than 250 degrees Celsius. Accordingly, a reliably detectable temperature change of the substrate at wavelength about 1200 nm ranges can be determined from about 25 degrees Celsius to about 200 degrees Celsius. Thus, by measuring the change in substrate transmittance at a carefully chosen wavelength, the substrate temperature may be reliably and precisely measured.

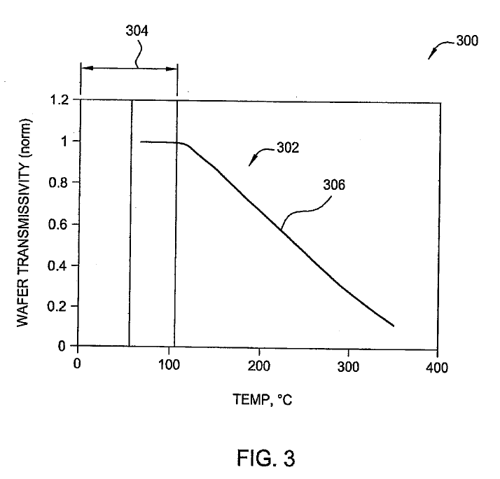

FIG. 3 depicts substrate light transmissivity as the substrate temperature elevates measured at a wavelength about 1200 nm. The trace 302 depicts the transmissivity of silicon semiconductor material as a function of temperatures between about 60 degrees Celsius and about 300 degrees Celsius. As the substrate is at a temperature below 60 degrees Celsius, the substrate light transmissivity remains constant, as shown in a first temperature zone 304, and is normalized as a base line relative to what is measured of the subsequent data points. As the substrate temperature elevates over a certain value, such as greater than 60 degrees Celsius, a change in substrate transmissivity is rapid. Accordingly, slope 360 of trace line 302 begins change more rapidly. As the substrate temperature increases, the slope of the trace line 302 changes and the substrate loses its transparency. Accordingly, based on the energy intensity measured, a substrate temperature may be determined.

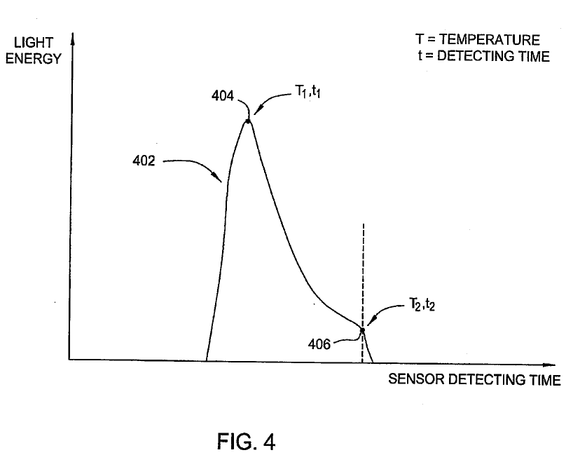

FIG. 4 depicts a trace 402 of IR light energy transmitted through the substrate 102 as a function of substrate temperature as detected by the controller 120. The energy trace 402 represents the change in light energy intensity transmitted through the substrate 102 as the temperature of the substrate increases. The substrate entering the apparatus 100 may have a low temperature T1 with high transmittance. Accordingly, substantial amount of light energy from the heater source 108 and/or or the signal generator 104 is transmitted through the substrate 102 to the sensor 106. As shown at point 404 on the trace 402, the sensor 106 indicates a high energy transmittance at an initial detecting time t1 at a low temperature T1. As the IR light is supplied to the substrate 102 at a constant level, the temperature of the substrate elevates. As the substrate temperature increases to a higher temperature T2, the change in the transmittance through silicon substrate decreases as the hotter substrate absorbs more IR light, resulting in a reduction of the transmitted IR energy. As shown at point 406 at time t2, the light energy detected by the sensor 106 is low due to the high absorption at high substrate temperature T2.

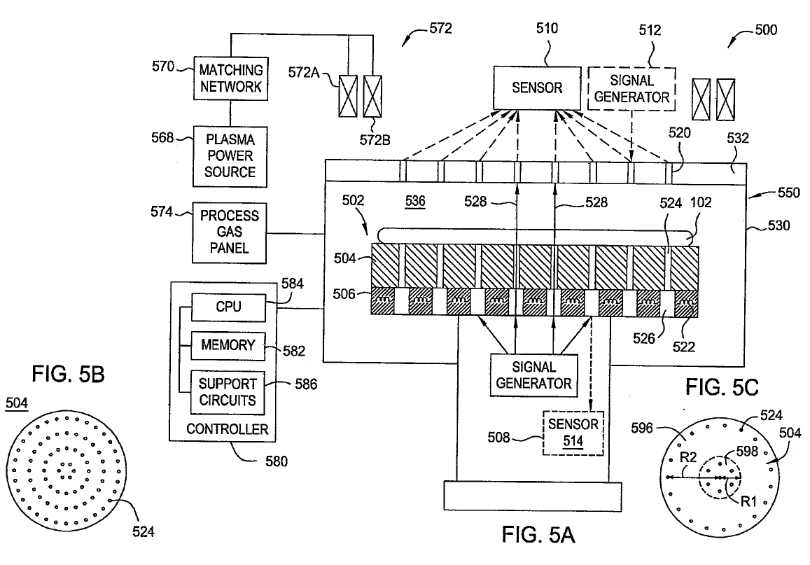

FIG. 5A depicts one embodiment of a process chamber 500 utilized to perform an etch or other plasma process on a substrate, such as the substrate 102 of FIG. 1A-C. The exemplary process chamber 500 includes one embodiment of a substrate pedestal assembly 502 and a chamber lid 532 that may illustratively be used to practice the invention. The particular embodiment of the process chamber 500 shown herein is provided for illustrative purposes and should not be used to limit the scope of the invention. In one embodiment, the process chamber may be a HART™ chamber available from Applied Materials, Inc. Alternatively, other process chambers, including those from other manufacturers, may be adapted to benefit from the invention.

The etch process chamber 500 generally includes a process chamber body 550, a gas panel 574 and a controller 580. The chamber body 500 includes a conductive body (wall) 530 and the chamber lid 532 that enclose a process volume 536. Process gasses are provided to the process volume 536 of the chamber 500 from the gas panel 574.

The controller 580 includes a central processing unit (CPU) 584, a memory 582, and support circuits 586. The controller 580 is coupled to and controls components of the process chamber 500, processes performed in the process chamber 500, as well as may facilitate an optional data exchange with databases of an integrated circuit fab.

In one embodiment, at least one signal generator 508 is positioned relative to the process chamber signal for substrate temperature measurement will impinge at least a portion of a substrate supported on the pedestal assembly 502. At least one sensor 510 is positioned to receive a portion of the signal generated from the signal generator 508 transmitted through the substrate. In certain embodiment, one or more pair of signal source 512 and the sensor 514 may be utilized to detect substrate temperature at different regions of the substrate. Configuration and arrangement of the signal generators and sensors may be similar to the configurations of the signal generator 104 and the sensor 106 discussed above with referenced to FIGS. 1A-C.

In one embodiment, the signal generator 508 is laser or other light source that may provide infrared radiation having a wavelength between about 1000 nm and about 1400 nm, such as between about 1050 nm and about 1300 nm, for example, between about 1100 nm and about 1200 nm. The wavelength of the signal generator 508 is selected to have a high change in transmittance through the materials and/or films being processed in the range of temperature for which measurement is sought, for example, a temperature of a substrate during an etch process.

In one embodiment, the sensor 510 is an InGaAs diode sensor. The sensor 510 detects collected energy passing through substrate 102. A filter (not shown) may be disposed adjacent to the sensor 510 to filter the signal collected and only allow IR light within a desired wavelength to reach the sensor 510. The sensor 510 provides a metric indicative of the light energy reaching to the sensor 510 which is then further analyzed by the controller 580 to calculate the temperature of the substrate 102.

In the depicted embodiment, the chamber lid 532 is a substantially flat dielectric member. Other embodiments of the process chamber 500 may have other types of ceilings, e.g., a dome-shaped ceiling. Above the chamber lid 532 is disposed an antenna 572 comprising one or more inductive coil elements (two co-axial coil elements 572A and 572B are illustratively shown). The antenna 572 is coupled, through a first matching network 570, to a radio-frequency (RF) plasma power source 568.

In one embodiment, the chamber lid 532 may have a plurality of window plugs 520 formed therein. The plugs 520 may be removable to facilitate ease of replacement of the plugs 520. In one embodiment, the plugs 520 are optical access windows that allow light from the signal generator 508 to pass through the windows to the sensor 510. It is noted that configurations, arrangement and functions of the signal generator 508 and the sensor 510 are similar to the signal generator 104 and the sensor 106 described above with referenced to FIGS. 1A-C.

In one embodiment, the substrate pedestal assembly 502 includes an electrostatic chuck 504 disposed on a base plate 506. Associated description of other substrate support assembly components and parts necessitated to compose the substrate support assembly 502 is hereby eliminated for the sake of brevity. One embodiment of the substrate support assembly 502 used herein may be referenced to United States Patents Application No. 2006/0076108 published to Holland, which is hereby incorporated by reference.

In one embodiment, the substrate support assembly 502 further comprises at least one optional embedded heater 522 or a plurality of optional conduits (not shown) facilitated to supply heating or cooling liquid to the substrate support assembly 502. The heater 522 and the conduits are utilized to control the temperature of the substrate support assembly 502, thereby controlling the temperature of a substrate 102 disposed thereon during etching processing.

In one embodiment, a plurality of window plugs 524 are formed within the body of the electrostatic chuck 504 to facilitate transmission of signals from the signal generator 508. The base plate 506 may also have a plurality of apertures and/or windows 526 formed therein that align with the windows 524 formed in the electrostatic chuck 504. The aligned windows 526, 524 in the base plate 506 and the electrostatic chuck 504 allow the signal 528 from the signal generator 508 to pass therethrough with minimal refraction. In the embodiment wherein the sensor and the signal source are at opposite side of the substrate 102 as depicted in FIG. 5A and 1C, the aligned windows 526, 524 formed in the substrate support assembly 502 are further aligned with the windows 520 formed in the chamber lid 532 to facilitate light transmission therethrough to the sensor 510 disposed above the chamber lid 532. Furthermore, the aligned windows 526, 524 also facilities signals from a second signal source 512 disposed above the chamber lid 532 to pass therethrough to a second sensor 514 disposed below the substrate support assembly 502.

In one embodiment, number and distribution of the windows 524, 526, 520 formed in the substrate support assembly 502 and the chamber lid 532 are configured in a manner to enable detection of temperature uniformity across the entire substrate surface, for example, in at least edge and center locations. Different configurations and distribution of the windows 524, 526, 520 facilitate signals to be transmitted to different regions and zones of the substrate for detection of each pinpoint temperature located at different regions and zones across the substrate surface. Once each pinpoint substrate temperature is determined, a temperature uniformity and temperature profile of the substrate 102 may be obtained. Accordingly, the heating or cooling fluid supplied to control the temperature of the substrate support assembly 502 may be adjusted in accordance with the measured temperature profile to control and maintain the overall substrate temperature uniformity.

In one embodiment, the windows 524, 526, 520 may be fabricated from quartz, sapphire and other ceramic material transmissive to the sensing signal and compatible with the materials selected to fabricate the substrate support assembly 502 and the chamber lid 532. The windows 524, 526, 520 may be in form of plugs that can easily be removed and replaced from the substrate support assembly 502 and the chamber lid 532. The plugs of windows 524, 526, 520 may be sintered, clamped or mounted by other suitable manner to the substrate support assembly 502 and the chamber lid 532.

It is noted that the window plugs 524, 526 may be formed only in the substrate support assembly 502, similar to the configuration described in FIG. 1B, or the window plugs 520 may be formed only in the chamber lid 532, similar to the configuration described in FIG. 1A. Alternatively, the window plugs 524, 526, 520 may be formed in both the chamber lid 532 and the substrate support assembly 502, similar to the configuration described in FIG. 1C and FIG. 5A.

FIG. 5B depicts a top view of the electrostatic chuck 504 having the windows 524 sintered and mounted therein. The windows 524 may be uniformly distributed across the surface of the electrostatic chuck 504 that allows signal to be passed therethrough to detect substrate temperature. Each window 524 formed therein may be substantially equal distance to each other and adapted to measure different regions and zones of the substrate temperature. Similarly, the distribution and configuration of the windows 520 formed in the chamber lid 532 may be similarly configured to allow signal to be passed therethrough to detect temperature in different regions of the substrate by a change in transmissivity.

FIG. 5C depicts a top view of another embodiment of the electrostatic chuck 504 having different numbers and configurations of the windows 524 sintered and mounted therein. The electrostatic chuck 504 may have a center zone 598 having a first radius R1 and a periphery zone 596 having a second radius R2. The first radius R1 may have a length between about 0 mm and about 75 mm and the second radius R2 may have a length between about 75 mm and about 150 mm. Alternatively, the second radius R2 may be controlled at a length about double or triple the length of the first radius R1. The windows 524 may be substantially formed within the center zone 598 and/or formed in the periphery zone 596 configured in the electrostatic chuck 504. Alternatively, the windows 524 may be formed in any configuration or distribution as needed.

In operation, the substrate 102 is transferred into the process chamber 500 to perform an etch process. It is contemplated that the chamber 500 may be configured to perform other processes, such as a deposition process, an anneal process, or other any other process that would benefit from substrate temperature measurement. In one embodiment, the substrate 102 may be any substrate or material on which an etch process or other process is to be performed. In one embodiment, the substrate may be a silicon semiconductor substrate having a layer or layers formed thereon utilized to form a structure, such as a gate structure. The substrate may alternatively utilize a mask layer as an etch mask and/or etch stop layer disposed on the substrate to promote the transfer of the features or structures to the substrate. In another embodiment, the substrate a silicon semiconductor substrate having multiple layers, e.g., a film stack, utilized to form different patterns and/or features, such as a dual damascene structure and the like. The substrate may be a material such as crystalline silicon (e.g., Si<100> or Si<111>), silicon oxide, strained silicon, silicon germanium, doped or undoped polysilicon, doped or undoped silicon wafers and patterned or non-patterned wafers silicon on insulator (SOI), carbon doped silicon oxides, silicon nitride, doped silicon, germanium, gallium arsenide, glass, sapphire, metal layers disposed on silicon and the like. The substrate may have various dimensions, such as 200 mm or 300 mm diameter wafers, as well as rectangular or square panels. In one embodiment, the substrate is a silicon semiconductor substrate.

In one embodiment, the substrate transferred to the processing chambers 500 is etched by supplying a gas mixture having at least a halogen-containing gas. Suitable examples of halogen-containing gas include, but not limited to, hydrogen bromide (HBr), chlorine (Cl₂), carbon tetrafluoride (CF₄), and the like. During etching, the light source, such as the signal generator 508 is turned on to provide IR radiation to the substrate surface. In one embodiment, the signal generators 508 generate infrared light at wavelengths between about 1000 nm and about 1400 nm, with very high intensity at the measurement wavelength of 1200 nm. In one embodiment, the intensity is between about 50 milliwafts and about 1000 milliwatts. Information from the sensor 510 is utilized on to detect the IR light from the signal generator 508 transmitted through the substrate 102 after the signal generator 508 has reached a steady state output establishing a baseline transmittance reading. The sensor 510 is turned on after the output from the signal generator 508 has been stabilized. In one embodiment, the output is stabilized after between about 2 second and about 5 seconds.

As previously discussed, the transmissivity of the substrate at different substrate temperatures significantly influences the amount of light energy passed through the substrate 102 and further to the sensor 510. As the substrate temperature elevates, the amount of light energy passed through the substrate 102 varies, thereby causing a change of the amount of the light energy transmitted to the sensor 510. Accordingly, the sensor 510 provides a metric indicative of the change in transmissivity which may be utilized to determine the substrate temperature. Based on the metric indicative of the change in transmissivity, the substrate temperature may be accordingly determined. Details regarding how the metric indicative of the change in transmissivity may be obtained in the U.S. patent application Ser. No. 11/676,092 filed by Davis, which is incorporated by reference.

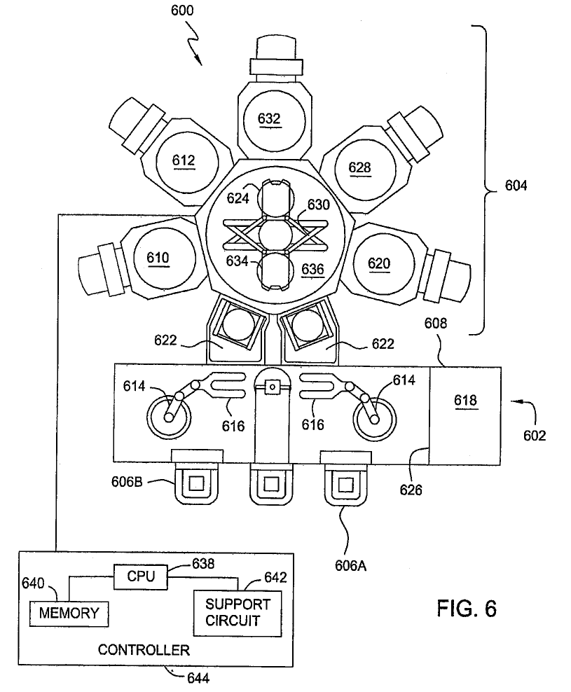

FIG. 6 is a schematic, top plan view of an exemplary processing system 600 that includes at least one region configured to include the apparatus 500 as depicted in FIG. 5 respectively for performing a substrate temperature measure during an etch process. In one embodiment, the processing system 600 may be a suitably adapted CENTURA® integrated processing system, commercially available from Applied Materials, Inc., located in Santa Clara, Calif. It is contemplated that other processing systems (including those from other manufacturers) may be adapted to benefit from the invention.

The system 600 includes a vacuum-tight processing platform 604, a factory interface 602, and a system controller 644. The platform 604 includes a plurality of processing chambers 500, 612, 632, 628, 620 and at least one load-lock chamber 622 that are coupled to a vacuum substrate transfer chamber 636. Two load lock chambers 622 are shown in FIG. 6. The factory interface 602 is coupled to the transfer chamber 636 by the load lock chambers 622.

In one embodiment, the factory interface 602 comprises at least one docking station 608 and at least one factory interface robot 614 to facilitate transfer of substrates. The docking station 608 is configured to accept one or more front opening unified pod (FOUP). Two FOUPS 606A-B are shown in the embodiment of FIG. 6. The factory interface robot 614 having a blade 616 disposed on one end of the robot 614 is configured to transfer the substrate from the factory interface 602 to the load lock chambers 622 of the processing platform 604. Optionally, one or more metrology stations 618 may be connected to a terminal 626 of the factory interface 602 to facilitate measurement of substrates while within the factory interface 602.

Each of the load lock chambers 622 have a first port coupled to the factory interface 602 and a second port coupled to the transfer chamber 736. The load lock chambers 622 are coupled to a pressure control system (not shown) which pumps down and vents the load lock chambers 622 to facilitate passing the substrate between the vacuum environment of the transfer chamber 636 and the substantially ambient (e.g., atmospheric) environment of the factory interface 602.

The transfer chamber 636 has a vacuum robot 630 disposed therein. The vacuum robot 630 has a blade 634 capable of transferring substrates 624 between the load lock chambers 622 and the processing chambers 500, 612, 632, 628, 620.

In one embodiment, at least one process chambers 500, 612, 632, 628, 620 is an etch chamber. For example, the etch chamber may be a HART™ chamber available from Applied Materials, Inc. The etch chamber, for example, the chamber 500 may use a halogen-containing gas to etch the substrate 102 disposed therein. Examples of halogen-containing gas include hydrogen bromide (HBr), chlorine (Cl₂), carbon tetrafluoride (CF₄), and the like. During the etching process in any of the process chambers 500, 612, 632, 628, 620, a sensor, such as the sensor 510, 514 of FIG. 5, is used to monitor the signal intensity passed through the substrate during the etching process which is correlated to substrate temperature.

The system controller 644 is coupled to the processing system 600. The system controller 644 controls the operation of the system 600 using a direct control of the process chambers 500, 612, 632, 628, 620 of the system 600 or alternatively, by controlling the computers (or controllers) associated with the process chambers 500, 612, 632, 628, 620 and the system 600. In operation, the system controller 644 enables data collection and feedback from the respective chambers and system controller 644 to optimize performance of the system 600.

The system controller 644 generally includes a central processing unit (CPU) 638, a memory 640, and support circuit 642. The CPU 638 may be one of any form of a general purpose computer processor that can be used in an industrial setting. The support circuits 642 are conventionally coupled to the CPU 638 and may comprise cache, clock circuits, input/output subsystems, power supplies, and the like. The software routines when executed by the CPU 638, transform the CPU 638 into a specific purpose computer (controller) 644. The software routines may also be stored and/or executed by a second controller (not shown) that is located remotely from the system 600.

Thus, the present invention provides a method and apparatus for measuring a substrate temperature during an etch process. The method and apparatus advantageously monitors the actual substrate temperature by a sensor during the etch process by measuring the IR transmittance transmitted through the substrate. The opacity of the substrate at different temperature provides different amount of IR transmittance passing through the substrate, thereby assisting the sensor to determine the actual substrate temperature. Advantageously, embodiments of the invention provide multiple windows that facilitate determining temperature profiles and gradient of a substrate during processing using a non-contact, non-evasive, real-time method.

While the foregoing is directed to embodiments of the present invention, other and further embodiments of the invention may be devised without departing from the basic scope thereof, and the scope thereof is determined by the claims that follow.

1. An apparatus for measuring a substrate temperature during an etching process, comprising:
a chamber body having a chamber lid enclosing the chamber body;
a substrate support assembly disposed in the chamber body and having a substrate supporting surface;
a plurality of windows formed in the substrate supporting surface;
a signal generator optically coupled through the substrate support assembly to the windows; and
a sensor positioned above the substrate support and aligned to receive energy transmitted from the signal generator through at least one of the window plugs, wherein the sensor is configured to detect a metric indicative of transmittance.

2. The apparatus of claim 1, further comprising:
a plurality of lid windows formed in the chamber lid, at least one of the lid windows formed in the chamber lid isolating the sensor from an interior of the chamber body.

3. The apparatus of claim 1, wherein the signal generator is configured to provide infrared light at a wavelength between about 1000 nm and about 1400 nm.

4. The apparatus of claim 1, wherein the windows are fabricated from quartz, sapphire or other ceramic material transmissive infrared light at a wavelength between about 1000 nm and about 1400 nm.

5. The apparatus of claim 1 further comprising:
a second signal generator arranged to generate signal directed downward to the substrate supporting surface; and
a second sensor arranged to correct a portion of the signal of the second signal generator that passes through the windows of the substrate support assembly.

6. The apparatus of claim 5 further comprising:
a plurality of lid windows formed in the chamber lid, at least one of the lid windows formed in the chamber lid isolating the second signal generator from an interior of the chamber body.

7. The apparatus of claim 1 further comprising:
a filter positioned to filter the signal directed to the sensor.

8. The apparatus of claim 1, wherein the windows are distributed across the substrate support surface.

9. The apparatus of claim 1, wherein the windows include at least inner window positioned near a centerline of the substrate support assembly, and a plurality of outer windows positioned at a greater radial position from the centerline relative to a position of the inner window.

10. The apparatus of claim 9, wherein the at least one of the outer window is positioned between about 75 mm and about 150 mm from the inner window.

11. The apparatus of claim 9, further comprising:
a plurality of lid windows formed in the chamber lid, the lid windows aligning with the windows formed in the substrate support.

12. A method of measuring a substrate temperature during an etching process comprising:
providing a substrate in a process chamber;
performing an etching process on the substrate;
detecting a change in transmittance of the substrate while etching; and
determining a temperature of the substrate based on the change in transmittance.

13. The method of claim 12, wherein detecting the change in transmittance of the substrate comprises:
directing a signal through the substrate, the signal having a wavelength between about 1000 nm and about 1400 nm.

14. The method of claim 12, wherein detecting the change in transmittance of the substrate comprises:
directing a signal through the substrate, the signal having a wavelength between about 1000 nm and about 1400 nm.

15. The method of claim 13, wherein detecting the change in transmittance further comprises:
collecting light transmitted through the substrate and substrate support assembly.

16. The method of claim 15, wherein the transmitted light is collected below the substrate.

17. The method of claim 15, wherein the transmitted light is reflected from a top surface of the substrate and collected below the substrate.

18. The method of claim 13, wherein detecting the change in transmittance further comprises:
analyzing a first signal passing through a center portion of the substrate; and
analyzing a second signal passing through the substrate outward of the center portion.

19. A method for measuring temperature during a process performed on a workpiece, comprising:
performing a process on a workpiece which changes the temperature of the workpiece;
passing an infrared light through the workpiece while performing the process;
detecting a metric of the transmitted infrared light indicative of the transmissivity of the workpiece; and
calculating a workpiece temperature based on the detected metric.

20. The method of claim 19, wherein the workpiece is a semiconductor wafer and detecting comprises:
directing infrared light having a wavelength between about 1000 nm and about 1400 nm through the workpiece.

21. The method of claim 20, wherein detecting comprises:
detecting metrics of infrared light transmitted through different regions the workpiece.
